(19) United States
(12) Patent Application Publication
(10) Pub. No.: US 2005/0280674 A1
(43) Pub. Date: Dec. 22, 2005

(54) Process for modifying the surface profile of an ink supply channel in a printhead

(76) Inventor: Darrell LaRue McReynolds, Balmain (AU)

Correspondence Address: SILVERBROOK RESEARCH PTY LTD, 393 DARLING STREET, BALMAIN, 2041, AU

(21) Appl. No.: 10/868,866

(22) Filed: Jun. 17, 2004

(51) Int. Cl. B41J 2/04

(52) U.S. Cl. 347/65

(57) ABSTRACT

A process for modifying the surface profile of an ink supply channel in a printhead is provided. The process comprises the steps of providing a printhead comprising ink supply channels, and ion milling the ink supply channel. The ion milling is generally performed with argon and tends to taper and/or round angular sidewall features in the channel.

### FIELD OF THE INVENTION

This invention relates to a process for modifying the surface profile of an ink supply channel in a printhead. It has been developed primarily to minimize angular sidewall projections in the ink supply channels, which can disrupt the flow of ink.

Co-Pending Application

Various methods, systems and apparatus relating to the present invention are disclosed in the following co-pending application filed by the applicant or assignee of the present invention simultaneously with the present application:
MEMS19US
   The disclosure of this co-pending application is incorporated herein by cross-reference. The application is temporarily identified by its docket number. This will be replaced by the corresponding USSN when available.

### BACKGROUND OF THE INVENTION

The impact of MEMS (Microelectromechanical Systems) devices on the microelectronics industry has been extremely significant in recent years. Indeed, MEMS is one of the fastest growing areas of microelectronics. The growth of MEMS has been enabled, to a large extent, by the extension of silicon-based photolithography to the manufacture of micro-scale mechanical devices and structures. Photolithographic techniques, of course, rely on reliable etching techniques, which allow accurate etching of a silicon substrate revealed beneath a mask.

MEMS devices have found applications in a wide variety of fields, such as in physical, chemical and biological sensing devices. One important application of MEMS devices is in inkjet printheads, where micro-scale actuators for inkjet nozzles may be manufactured using MEMS techniques. The present Applicant has developed printheads incorporating MEMS ink ejection devices and these are described in the following patents and patent applications, all of which are incorporated herein by reference.

| | | | | |
|---|---|---|---|---|
| 6,227,652 | 6,213,588 | 6,213,589 | 6,231,163 | 6,247,795 |
| 09/113,099 | 6,244,691 | 6,257,704 | 09/112,778 | 6,220,694 |
| 6,257,705 | 6,247,794 | 6,234,610 | 6,247,793 | 6,264,306 |
| 6,241,342 | 6,247,792 | 6,264,307 | 6,254,220 | 6,234,611 |
| 09/112,808 | 09/112,809 | 6,239,821 | 09/113,083 | 6,247,796 |
| 09/113,122 | 09/112,793 | 09/112,794 | 09/113,128 | 09/113,127 |
| 6,227,653 | 6,234,609 | 6,238,040 | 6,188,415 | 6,227,654 |
| 6,209,989 | 6,247,791 | 09/112,764 | 6,217,153 | 09/112,767 |
| 6,243,113 | 09/112,807 | 6,247,790 | 6,260,953 | 6,267,469 |
| 09/425,419 | 09/425,418 | 09/425,194 | 09/425,193 | 09/422,892 |
| 09/422,806 | 09/425,420 | 09/422,893 | 09/693,703 | 09/693,706 |
| 09/693,313 | 09/693,279 | 09/693,727 | 09/693,708 | 09/575,141 |
| 09/113,053 | 10/302,274 | | | |

Typically a MEMS inkjet printhead (“MEMJET printhead”) is comprised of a plurality of chips, with each chip having several thousand nozzles. Each nozzle comprises an actuator for ejecting ink, which may be, for example, a thermal bend actuator (e.g. U.S. Pat. No. 6,322,195) or a bubble-forming heater element actuator (e.g. U.S. Pat. No. 6,672,709). The chips are manufactured using MEMS techniques, meaning that a high nozzle density and, hence, high resolution printheads can be mass-produced at relatively low cost.

In the manufacture of MEMS printhead chips, it is often required to perform deep or ultradeep etches. Etch depths of about 3 μm to 10 μm may be termed “deep etches”, whereas etch depths of more than about 10 μm may be termed “ultradeep etches.

MEMS printhead chips typically require delivery of ink to each nozzle through individual ink supply channels having a diameter of about 20 μm. These ink channels are typically etched through wafers having a thickness of about 200 μm, and therefore place considerable demands on the etching method employed. It is especially important that each ink channel is perpendicular to the wafer surface and does not contain kinks, sidewall projections (e.g. grassing) or angular junctions, which can interfere with the flow of ink.

In the Applicant's U.S. patent application Ser. No. 10/728,784 (Applicant Ref: MTB08) and Ser. No. 10/728,970 (Applicant Ref: MTB07), both of which are incorporated herein by reference, there is described a method of fabricating inkjet printheads from a wafer having a drop ejection side and an ink supply side. Referring to FIG. 1, there is shown a typical MEMS nozzle arrangement 1 comprising a bubble-forming heater element actuator assembly 2. The actuator assembly 2 is formed in a nozzle chamber 3 on the passivation layer 4 of a silicon wafer 5. The wafer typically has a thickness “B” of about 200 μm, whilst the nozzle chamber typically occupies a thickness “A” of about 20 μm.

Referring to FIG. 2, an ink supply channel 6 is etched through the wafer 5 to the CMOS metallization layers of an interconnect 7. An inlet 8 provides fluid connection between the ink supply channel 6 and the nozzle chamber (removed for clarity in FIG. 2). CMOS drive circuitry 9 is provided between the wafer 5 and the interconnect 7. The actuator assembly 2, associated drive circuitry 9 and ink supply channel 6 may be formed on and through a wafer 3 by lithographically masked etching techniques, as described in U.S. application Ser. No. 10/302,274, which is incorporated herein by reference.

Referring to FIG. 3, the ink supply channel 6 is formed in the wafer 5 by first etching a trench partially through the wafer 5 from the drop ejection side (i.e. nozzle side) of the wafer. (This trench will become the inlet 8, shown in FIG. 2). Once formed, the trench is plugged with photoresist 10, as shown in FIG. 3, and the ink supply channel 6, is formed by ultradeep etching from the ink supply side of the wafer 5 to the photresist plug 10. Finally, the photoresist 10 is stripped from the trench to form the inlet 8, which provides fluid connection between the ink supply channel 6 and the nozzle chamber 3.

This “back-etching” technique avoids filling and removing an entire 200 μm long ink supply channel with resist whilst nozzle structures in the wafer are being lithographically formed. However, there are a number of problems associated with back-etching the ink supply channels in this way. Firstly, the mask on the ink supply side needs to be carefully aligned so that the etched channels meet the trenches plugged with photoresist, and do not damage the drive circuitry 9. Secondly, the etching needs to be perpendicular and anisotropic to a depth of about 200 μm. Thirdly, angular sidewall features in the ink channel, especially at the junction of the ink channel 6 with the inlet 8, are produced. These angular shoulders should ideally be minimized to allow smooth ink flow. Accordingly, there is a demand for improved etching methods, which allow ultradeep trenches having relatively smooth sidewalls to be made in silicon wafers.

Several methods for etching ultradeep trenches into silicon are known in the art. All these methods involve deep reactive ion etching (DRIE) using a gas plasma. The semiconductor substrate, with a suitable mask disposed thereon, is placed on a lower electrode in a plasma reactor, and exposed to an ionized gas plasma formed from a mixture of gases. The ionized plasma gases (usually positively charged) are accelerated towards the substrate by a biasing voltage applied to the electrode. The plasma gases etch the substrate either by physical bombardment, chemical reaction or a combination of both. Etching of silicon is usually ultimately achieved by formation of volatile silicon halides, such as SiF₄, which are carried away from the etch front by a light inert carrier gas, such as helium.

Anisotropic etching is generally achieved by depositing a passivation layer onto the base and sidewalls of the trench as it is being formed, and selectively etching the base of the trench using the gas plasma.

One method for achieving ultradeep anisotropic etching is the “Bosch process”, described in U.S. Pat. No. 5,501,893 and U.S. Pat. No. 6,284,148. This method involves alternating polymer deposition and etching steps. After formation of a shallow trench, a first polymer deposition step deposits a polymer onto the base and side walls of the trench. The polymer is deposited by a gas plasma formed from a fluorinated gas (e.g. CHF₃, C₄F₈ or C₂F₄) in the presence or in the absence of an inert gas. In the subsequent etching step, the plasma gas mix is changed to SF₆/Ar. The polymer deposited on the base of the trench is quickly broken up by ion assistance in the etching step, while the sidewalls remain protected. Hence, anisotropic etching may be achieved. However, a major disadvantage of the Bosch process is that polymer deposition and etching steps need to be alternated, which means continuously alternating the gas composition of the plasma. This alternation, in turn, leads to uneven trench sidewalls, characterized by scalloped surface formations.

At worst, the Bosch process tends to leave grass-like spikes in the sidewalls of the trenches due to incomplete removal of the polymer passivation layer. These grass-like residues are especially undesirable in ink supply channels, because ink flow through the channels may break off the grassy spikes and block the ink nozzles downstream. Furthermore, sharp sidewall projections create air pockets in the ink, which can lead to poor ink flow and, hence, poor print quality and/or nozzle blocking.

A modification of the cyclical Bosch process is described in U.S. Pat. No. 6,127,278, assigned to Applied Materials, Inc. In the Applied Materials process, a first passivation etch is performed using a HBr/O₂ plasma, followed by a main etch using a SF₆/HBr/O₂ in alternating succession. The HBr enhances passivation, probably by formation of relatively nonvolatile silicon bromides in the passivation layer. However, this cyclical passivation/etching process still suffers from grassing and scalloped sidewalls, which are evident in the Bosch process.

Another ultradeep anisotropic etching process is the “Lam process”, described in U.S. Pat. No. 6,191,043. The Lam process utilizes a constant, non-alternating plasma gas chemistry of SF₆/O₂/Ar/He and achieves simultaneous sidewall passivation during the etch. To some extent, this avoids the problems of scalloped sidewalls and grassing resulting from cyclical etching processes.

However, there is still a need to improve the surface profiles of ultradeep trenches in order to minimize the deleterious effects of grassing and scalloped sidewalls. It would be especially desirable to minimize angular junctions between nozzle inlets and ink supply channels in printheads. As discussed above, angular shoulder junctions are a common problem when “back-etching” ink supply channels from the ink supply side of printhead wafers.

### SUMMARY OF THE INVENTION

In a first aspect, the present invention provides a process for modifying the surface profile of an ink supply channel in a printhead, said process comprising the steps of:
(i) providing a printhead comprising at least one ink supply channel; and
(ii) ion milling the at least one ink supply channel.

In a second aspect, the present invention provides a method of fabricating an inkjet printhead comprising a plurality of nozzles, ejection actuators, associated drive circuitry and ink supply channels, said method comprising the steps of:
(i) providing a wafer having a drop ejection side and an ink supply side;
(ii) etching a plurality of trenches partially through said drop ejection side of said wafer;
(iii) filling said trenches with photoresist;
(iv) forming a plurality of corresponding nozzles, ejection actuators and associated drive circuitry on said drop ejection side of said wafer using lithographically masked etching techniques;
(v) etching a plurality of corresponding ink supply channels from said ink supply side of said wafer to said photoresist;
(vi) modifying the surface profiles of said ink supply channels by ion milling; and
(vii) stripping said photoresist from said trenches to form nozzle inlets, thereby providing fluid connection between said ink supply side and said nozzles.

In a third aspect, the present invention provides an inkjet printhead comprising:
a wafer having a drop ejection side and an ink supply side;
a plurality of nozzles formed on said drop ejection side, each of said nozzles having a corresponding inlet in said wafer; and
a plurality of corresponding ink supply channels leading to each inlet from said ink supply side,
   wherein shoulders defined by the junction of said ink supply channels with said inlets are tapered and/or rounded.

Hitherto, the importance of the surface profile of ink supply channels in printheads fabricated by MEMS techniques had not been fully appreciated. Whilst several ultradeep etching techniques have become available in recent years, none of these addresses the problems of grassing, scalloped sidewalls and/or angular shoulder junctions between nozzle inlets and ink supply channels. The present invention introduces an additional surface profile modifying step into the printhead manufacturing process, which has the effect of tapering and/or rounding angular surface features in the sidewalls of ink supply channels. Hence, printheads made by the process of the present invention generally exhibit improved ink flow through their ink supply channels.

Optionally, angular surface features in the sidewalls of ink supply channels are tapered and/or rounded by the ion milling. An angular surface feature may be, for example, a spike projecting inwardly from a sidewall. Alternatively, it may be an angled shoulder at the point where the ink supply channel narrows into a nozzle inlet. The process of the present invention advantageously tapers these angular surface features, such that they are generally rounded or smoothed off. Hence, ink flowing past these features approaches a curved surface rather than an angular surface. This means that the ink can flow smoothly past, without generating excessive turbulence and/or air bubbles in pockets behind jutting projections where ink is flowing relatively slowly.

Typically, the ink supply channel itself is formed by anisotropic ultradeep etching of a semiconductor (e.g. silicon) wafer. Any known anisotropic ultradeep etching technique, such as those described above, may be used to form the ink supply channels. A preferred technique is described in the Applicant's co-filed US patent application, entitled “Method Suitable for Etching Ultradeep Trenches in a Substrate”, the contents of which is incorporated herein by reference.

Optionally, the ion milling is performed in a plasma etching reactor, such as an inductively coupled plasma etching reactor. Plasma etching reactors are well known in the art and are commercially available from various sources (e.g. Surface Technology Systems, PLC). Typically, the etching reactor comprises a chamber formed from aluminium, glass or quartz, which contains a pair of parallel electrode plates. However, other designs of reactor are available and the present invention is suitable for use with any type of plasma etching reactor.

A radiofrequency (RF) energy source is used to ionize a plasma gas (or gas mixture) introduced into the chamber. The ionized gas is accelerated towards a substrate disposed on a lower electrode (electrostatic chuck) by a biasing voltage. In the present invention, etching is typically achieved purely by physical bombardment of the substrate. Various control means are provided for controlling the biasing voltage, the RF ionizing energy, the substrate temperature, the chamber pressure etc. It will, of course, be within the ambit of the skilled person's common general knowledge to vary plasma reactor parameters in order to optimize etching conditions.

Optionally, the ion milling is performed using a heavy inert gas selected from argon, krypton or xenon. Preferably, the inert gas is argon since this is widely available at relatively low cost, and, because of its relatively high mass, has excellent sputtering properties. Typically, an argon ion plasma is generated in a plasma etching reactor, and the argon ions accelerated perpendicularly towards a silicon wafer having ink supply channels etched therein.

The ion milling may be performed at any suitable pressure. Typically, the pressure will be in the range of 5 to 2000 mTorr. In other words, ion milling may be performed at low pressure (about 5 to 250 mTorr) or high pressure (about 250 to 2000 mTorr).

Low pressure ion milling has the advantage that most commercially available plasma etching reactors are configured for low pressure etching. Hence, low pressure ion milling does not require any special apparatus.

However, ion milling may also be performed at high pressure. High pressure ion milling has the advantage that steeper tapering is usually obtainable. The principle of using a high pressure ion milling to produce steep taper angles may be understood as follows. Normally, sputter etching is performed at relatively low pressures (e.g. about 50 to 250 mTorr) to achieve high sputter etching efficiency. Such a low pressure produces a nearly collision-free path for silicon atoms sputtered from the surface, thereby optimizing etching efficiency.

By sputter etching at high pressure rather than low pressure, the mean free path of sputtered silicon atoms is reduced, because sputtered (reflected) silicon atoms have a greater chance of colliding with incoming argon ions in the plasma gas. The result is that a gaseous cloud is formed above the substrate surface, which redeposits reflected silicon atoms back onto the silicon surface. There is an increasing net deposition of reflected silicon atoms at greater depths, which results in angular surface features in the sidewalls becoming more tapered.

U.S. Pat. No. 5,888,901, which is incorporated herein by reference, describes high pressure ion milling of a SiO₂ dielectric surface using argon as the sputtering gas. Whilst the method described in U.S. Pat. No. 5,888,901 is used for tapering a SiO₂ dielectric surface layer, rather than tapering angular surface features on the sidewalls of ultradeep channels etched into silicon, this method may be readily modified and applied to the process of the present invention.

Low pressure ion milling is generally preferred in the present invention, because it is usually only necessary to round off angular sidewall features in order to achieve improved ink flow, rather than taper the whole sidewall feature. Moreover, low pressure ion milling does not require any special apparatus and can therefore be easily incorporated into a typical printhead fabrication process.

Optionally, each ink supply channel has a depth in the range of 100 to 300 μm, optionally 150 to 250 μm, or optionally about 200 μm. Optionally, each ink supply channel has a diameter in the range of 5 to 30 μm, optionally 14 to 28 μm, or optionally 17 to 25 μm.

Optionally, each nozzle inlet has a depth in the range of 5 to 40 μm, optionally 10 to 30 μm, or optionally 15 to 25 μm. Optionally, each nozzle inlet has a diameter in the range of 3 to 28 μm, optionally 8 to 24 μm, or optionally 12 to 20 μm.

Usually, each ink supply channel has a larger diameter than its corresponding nozzle inlet, and the process of the present invention may be used to taper angular shoulders defined by the junction of the inlet and the channel.

### BRIEF DESCRIPTION OF THE DRAWINGS

FIG. 1 shows a perspective view of a prior art printhead nozzle arrangement for a printhead;

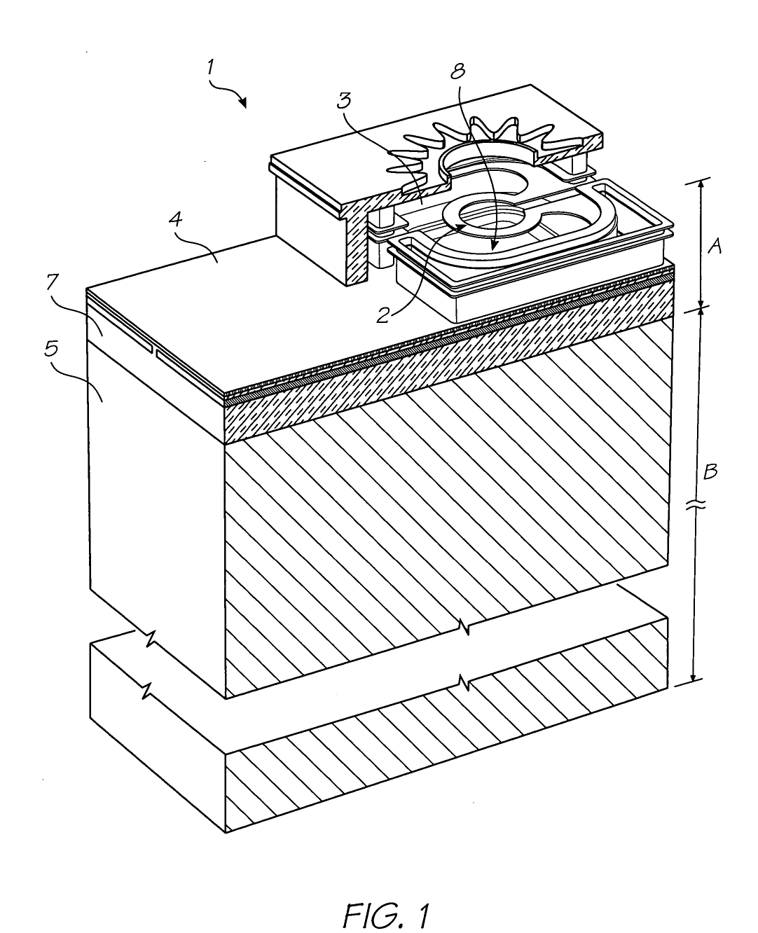

FIG. 2 is a cutaway perspective view of the prior art printhead nozzle arrangement shown in FIG. 1, with the actuator assembly removed and the ink supply channel exposed;

FIG. 3 is a cutaway perspective view of the printhead nozzle arrangement shown in FIG. 2 before stripping away the photoresist plug; and

FIG. 4 is a cutaway perspective view of a printhead nozzle arrangement according to the present invention, with the actuator assembly removed and the ink supply channel exposed.

### DETAILED DESCRIPTION OF A PREFERRED EMBODIMENT

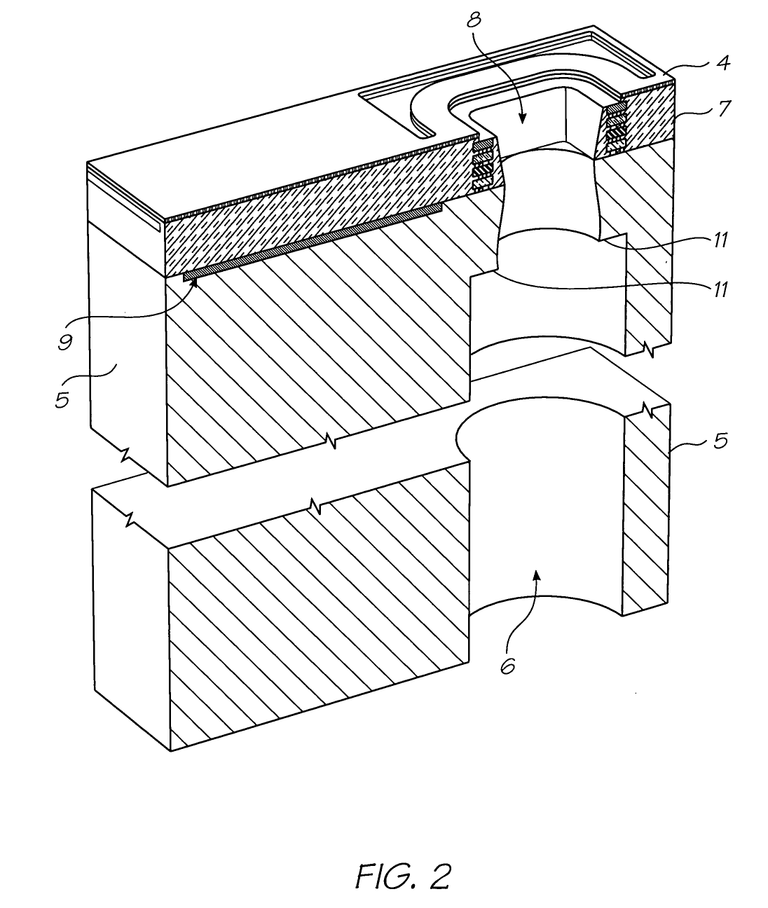

FIG. 2 shows a prior art printhead nozzle arrangement having angular shoulders 11, which define a junction between the ink supply channel 6 and the inlet 8. These angular shoulders are formed by prior art ultradeep etching methods described above and in the Applicant's U.S. patent application Ser. No. 10/728,784 (Applicant Ref: MTB08) and Ser. No. 10/728,970 (Applicant Ref: MTB07), both of which are incorporated herein by reference.

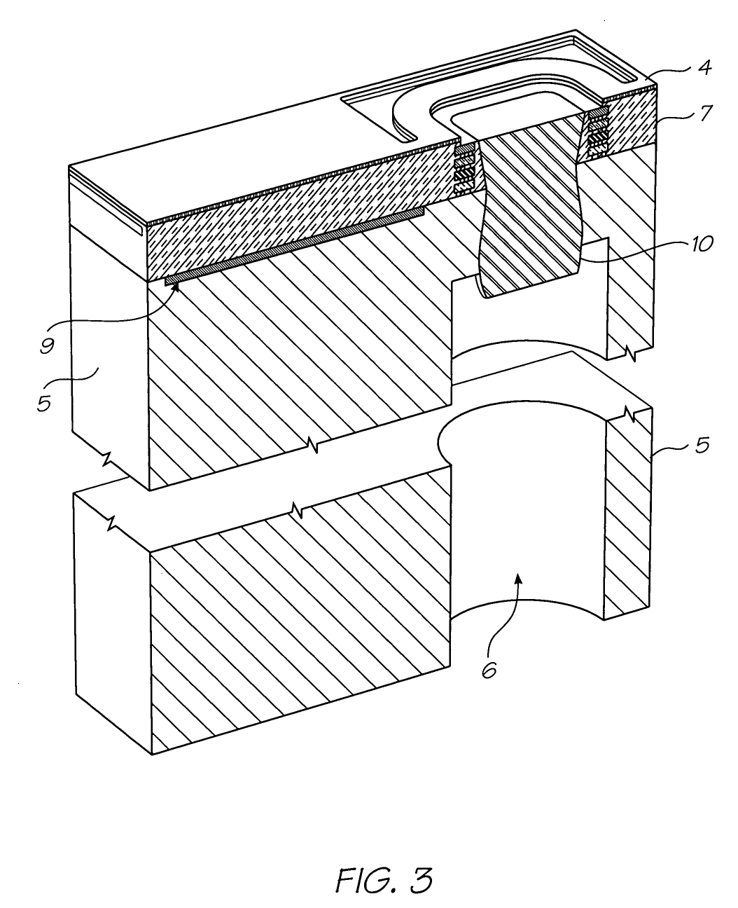

Referring to FIG. 3, there is shown an ink supply channel 6 before removal of the photoresist plug 10. The channel 6 is etched partially beyond and around the photoresist plug 10. In accordance with the present invention, at this stage of printhead fabrication, the wafer is subjected to argon ion milling in a plasma etching reactor. Optimal operating parameters of the plasma etching reactor may be readily determined by the person skilled in the art.

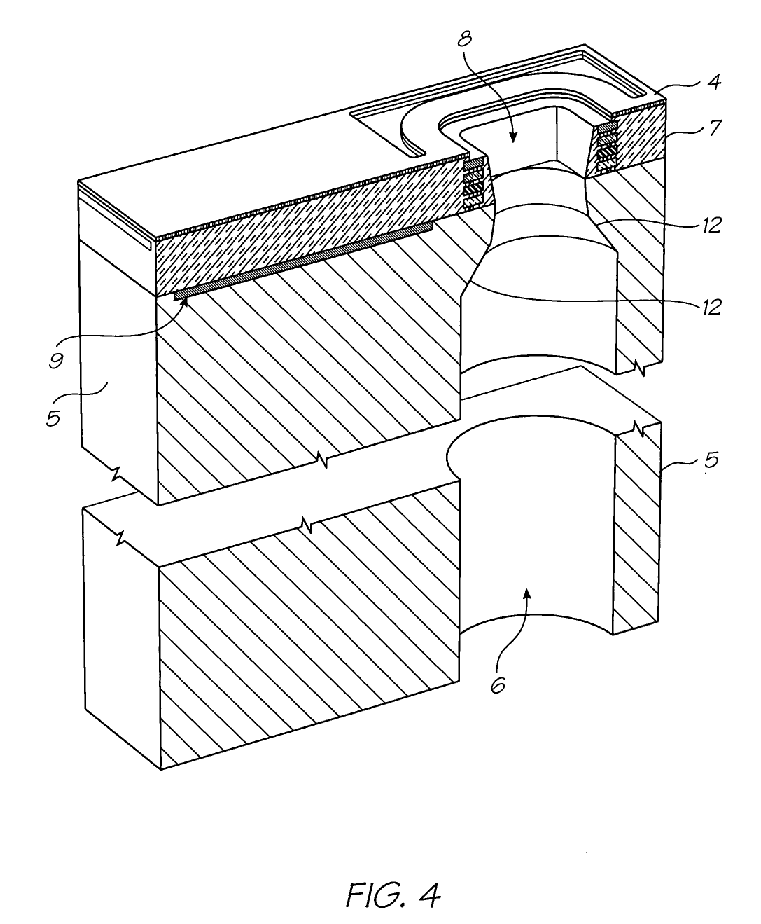

During the argon ion milling, the angular shoulders 11 are tapered by simultaneously etching and redepositing sputtered silicon back onto the sidewalls of the channel. The result is a printhead nozzle arrangement as shown in FIG. 4, having tapered shoulders 12, which define the junction between the inlet 8 and the ink supply channel 6.

Depending on the pressure, the bias power and/or the milling time, the shoulders may be either fully tapered (as shown in FIG. 4) or merely partially rounded. In either case, the removal of sharply angled shoulders 11 generally improves ink flow through the channel 6 and minimizes pockets of turbulence and/or air bubble formation.

It will, of course, be appreciated that the present invention has been described purely by way of example and that modifications of detail may be made within the scope of the invention, which is defined by the accompanying claims.

1. A process for modifying the surface profile of at least one ink supply channel in a printhead, said process comprising the steps of:
(i) providing a printhead comprising at least one ink supply channel; and
(ii) ion milling said at least one ink supply channel.

2. The process of claim 1, wherein said printhead comprises a plurality of ink supply channels.

3. The process of claim 1, wherein angular surface features in the sidewalls of said at least one channel are tapered and/or rounded by said ion milling.

4. The process of claim 1, wherein said ion milling is performed in a plasma etching reactor.

5. The process of claim 1, wherein said ion milling is performed with an inert gas selected from the group consisting of argon, krypton and xenon.

6. The process of claim 1, wherein said ion milling is performed at a pressure in the range of 5 to 2000 mTorr.

7. The process of claim 1, wherein said ink supply channel has a depth in the range of 100 to 300 μM.

8. The process of claim 1, wherein said ink supply channel has a diameter in the range of 2 to 30 μm.

9. A printhead comprising a plurality of ink supply channels, wherein said ink supply channels are modified by a process according to claim 1.

10. A method of fabricating an inkjet printhead comprising a plurality of nozzles, ejection actuators, associated drive circuitry and ink supply channels, said method comprising the steps of:
(i) providing a wafer having a drop ejection side and an ink supply side;
(ii) etching a plurality of trenches partially through said drop ejection side of said wafer;
(iii) filling said trenches with photoresist;
(iv) forming a plurality of corresponding nozzles, ejection actuators and associated drive circuitry on said drop ejection side of said wafer using lithographically masked etching techniques;
(v) etching a plurality of corresponding ink supply channels from said ink supply side of said wafer to said photoresist;
(vi) modifying the surface profiles of said ink supply channels by ion milling; and
(vii) stripping said photoresist from said trenches to form nozzle inlets, thereby providing fluid connection between said ink supply side and said nozzles.

11. The method of claim 10, wherein shoulders defined by the junction of said ink supply channels with said inlets are tapered and/or rounded by said ion milling.

12. The method of claim 10, wherein said trenches have a depth in the range of 5 to 150 μm.

13. The method of claim 10, wherein said ink supply channels and/or said trenches are etched by a method comprising the steps of:
(i) providing an etching gas plasma consisting essentially of:
(a) a passivating gas comprising oxygen;
(b) an inert sputtering gas selected from the group consisting of argon, krypton and xenon; and
(c) a fluorinated etching gas;
and (ii) etching a trench into said substrate using said etching gas plasma.

14. A printhead fabricated by a method according to claim 10.

15. An inkjet printhead comprising:
a wafer having a drop ejection side and an ink supply side;
a plurality of nozzles formed on said drop ejection side, each of said nozzles having a corresponding inlet in said wafer; and
a plurality of corresponding ink supply channels leading to each inlet from said ink supply side,
wherein shoulders defined by the junction of said ink supply channels with said inlets are tapered and/or rounded.

16. The inkjet printhead of claim 15, wherein each ink supply channel has a larger diameter than its corresponding inlet, and each channel tapers inwardly towards its corresponding inlet.

17. The inkjet printhead of claim 15, wherein each ink supply channel has a depth in the range of 100 to 300 μm.

18. The inkjet printhead of claim 15, wherein each ink supply channel has a diameter in the range of 5 to 30 μm.

19. The inkjet printhead of claim 15, wherein each inlet has a depth in the range of 5 to 40 μm.

20. The inkjet printhead of claim 15, wherein each inlet has a diameter in the range of 3 to 28 μm.
